(19) United States
(12) Patent Application Publication
(10) Pub. No.: US 2003/0084384 A1
(43) Pub. Date: May 1, 2003

(54) Residual error handling in a can network

(75) Inventors: William A. White III, Carlisle, MA (US); Lawrence W. Hill, North Eastham, MA (US); James A. McLean, York, ME (US); William D. Sparks, Litchfield, NH (US); Jean-Francois Rolland, Ruel Malmaison (FR)

Correspondence Address: SQUARE D COMPANY, 1415 South Roselle Road, Palatine, IL, 60067, US

(73) Assignee: Schneider Automation Inc.

(21) Appl. No.: 10/071,604

(22) Filed: Feb. 8, 2002

Related U.S. Application Data
(63) Continuation-in-part of application No. 10/045,517, filed on Oct. 26, 2001.
Application No. 10/045,517 is a continuation-in-part of application No. 10/045,723, filed on Oct. 26, 2001.

(51) Int. Cl. G06F 11/00

(52) U.S. Cl. 714/704

(57) ABSTRACT

A method and apparatus for improving communication throughout a network is disclosed. The network includes a module capable of transmitting messages in response to a change of state. Bit errors transmitted within network are detected and a detected bit error rate is calculated. A residual, i.e., undetected, error probability is determined in response to the detected bit error rate. Corrective action towards reducing the effects of the residual errors is taken, e.g., retransmission of messages, in response to the residual error probability exceeding a predetermined threshold.

### RELATED APPLICATIONS

This patent application is a continuation-in-part claiming benefit to and incorporating by reference, U.S. patent application Ser. No.'s 10/045,517 and 10/045,723, each filed Oct. 26, 2001 and entitled “HYBRID CHANGE STATE OF PROTOCOL FOR CANopen NETWORKS” and “TIME TRIGGERED COMMUNICATION NETWORK FOR CANopen NETWORKS,” (Attorney Docket No.'s SAA-73, 401 P 271 and SAA-74, 401 P 271).

### FEDERALLY SPONSORED RESEARCH OR DEVELOPMENT

Not Applicable.

### TECHNICAL FIELD

The present invention generally relates to network communication, and more particularly, to a method and apparatus for monitoring and controlling residual errors.

### BACKGROUND OF THE INVENTION

The CAN and CANOpen networks are well known. Typically, these networks include an intelligent master device and a plurality of I/O modules (slave devices) coupled to a serial communications bus. The network generally includes a plurality of analog I/O modules as well as a plurality of discrete (on/off) I/O modules. Current methods for transmitting data from the I/O modules to the master device are either: (1) timed data transmissions from each of the I/O modules to the master device; (2) random, change-of-state (COS) transmissions from the I/O modules to the master device any time the state of one of the I/O modules changes; or (3) timed requests from the master device to each of the I/O modules.

The CAN network was originally developed to allow for high speed data communication in automobiles. Generally, networks used within automobiles include a relatively limited number of I/O points and known bus lengths. These networks are exposed to electromagnetic interference. The robust character of the CAN network is ideally suited for use in the automotive industry. However, detection and control of some bit errors occurring during message transmission are undetectable and costly to control. See, Multi-Bit Error Vulnerabilities in the Controller Area Network Protocol, Tran, Doctoral thesis, Carnegie Mellon University, Pittsburgh, Pa., May 1999; and, Performance of the Error Detection Mechanisms in CAN, Charzinski, Proceedings of the 1^{st} International CAN Conference, Mainz, Germany, September 1994, pp 1.20-1.29; these references provide some background and context for the present invention and are incorporated herein by reference.

Common error mechanisms include: improper installation, excessive stub length, excessive bus length, EMI, inadequate grounding, high current switching, excessive capacitance, mechanically damaged contacts, vibration, corrosion, etc. Many of these error mechanisms occur and increase over a period of time, even if not present at system installation.

Typically, a detected raw bit error rate in the range of 10⁻⁴ or 10⁻³ can produce an undetected, or residual, error on the order of 10⁻¹⁰ or 10⁻¹¹. At this rate, a network having a 1 Mbps communication bus producing 4.4×10¹¹ messages a year would incur an error message every month. Residual errors occurring at a higher rate produce faulty system behavior. At best, these errors are viewed as a quality problem, and at worst, may cause significant damage.

To be consistent with commonly implemented hardware failure rates, a raw bit error rate of better than 10⁻⁵ is required, depending on the system characteristics, e.g., amount of nodes, average message length, etc. For instance, a properly terminate coaxial CATV cable with adequate signal levels will typically run below a 10⁻¹² bit error rate. A telephone modem generally runs in the range of 10⁻⁵ or 10⁻⁶ bit error rate.

The CAN protocol utilizes several error detection mechanisms: monitoring, cyclic redundancy check (CRC), message frame check; bit stuffing; acknowledgment; I/O module shutdown; and error signaling. CAN also utilizes redundant message transmission to combat undetected, i.e., residual, errors. Although retransmission of all information wastes bandwidth, the CAN network utilizing these error correction techniques operates satisfactorily.

The physical layer of the CAN bus utilizes bit-stuffing to maintain bit-level synchronization between transmitters and receivers. This method of ensuring accurate communication has been useful in the past, even though bit-stuffing significantly reduces the effectiveness of commonly used error detections codes, such as CRC-16. Ironically, bit-stuffing can exacerbate a communication problem by increasing bit errors into multiple errors occurring in an ensuing bit stream, i.e., the receiver makes a series of mistakes about which bits are stuffed and which are not. In a hybrid trigger protocol wherein data is sent only when the I/O module changes operating states, i.e., COS, a missed message or error bit may endure for a significant length of time.

CAN networks are increasingly being implemented in automation systems wherein communication bus length varies among network nodes—as opposed to the relatively constant bus lengths of wiring harnesses initially utilized in original automotive settings. Although more error control would be effective in automation systems implementing CAN, in these situations, the limitations associated with redundant transmissions adversely affect the network's bandwidth efficiency. There is a desire to improve error detection and control while remaining within the CAN standard protocol.

The present invention is provided to solve these and other problems.

### SUMMARY OF THE INVENTION

One embodiment of the present invention is directed to a method for improving network communication by reducing the effects of undetected bit errors. The method includes detecting an error and calculating a bit error rate. In response to the calculated detected bit error rate, an undetected error probability is determined. Corrective action is taken in response to the determined undetected error probability exceeding a predetermined threshold. Some examples of corrective action include: retransmitting network messages, shortening the network message length, and ceasing transmission of network messages.

Another embodiment of the present invention is directed to an apparatus for reducing the effect of undetected communication errors transmitted throughout a network. The network includes a module and is configured such that messages are transmitted from the module in response to a change of state of the module. The apparatus comprises a bit error detector. A calculator for determining a detected bit error rate is operably connected to the bit error detector. An extrapolator correlates the calculated detected bit error rate to an undetected bit error probability. A means for improving accurate message transmission is responsive to the undetected bit error probability exceeding a predetermined threshold wherein undetected errors transmitted throughout the network are bound to a predetermined threshold.

A further aspect of the present invention utilizes maximum-likelihood filtering, e.g., Kalman filtering, to facilitate correlating the undetected error probability.

Another further aspect of the present invention utilizes rate of deterioration, e.g., first time derivative of detected bit error rate, to facilitate correlating the undetected error probability.

An object of the present invention is to utilize a detected bit error rate to improve network communication by reducing the effects of undetected bit errors.

A further object of the present invention is directed to determining residual errors and controlling resultant adverse effects with minimal loss of bandwidth while complying with the CAN standard framework. The CAN network includes a device and an I/O module, each being communicatively coupled to a communication bus wherein the I/O module is subject to a state change.

These and other aspects and attributes of the present invention will be discussed with reference to the following drawings and accompanying specification.

### BRIEF DESCRIPTION OF THE DRAWINGS

FIG. 1 is a block diagram of one embodiment of the present invention;

FIG. 2 is a flow chart of one embodiment of the present invention;

FIG. 3 depicts an alternative embodiment of the present invention; and,

FIG. 4 depicts another embodiment of the present invention.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

An embodiment of a CAN network 10 is illustrated in FIG. 1. The network 10 includes a bus master 12. The bus master 12 may be a field bus coupler, a PLC (programmable logic controller) or such other intelligent master device. The network 10 further includes a plurality of I/O modules 14. The I/O modules 14 may be analog I/O devices, high priority discrete (on/off) I/O modules or low priority discrete (on/off) I/O modules. A bus 16 communicatively couples the bus master 12 and each of the I/O modules 14.

The discrete I/O modules 14 are subject to state changes. The high priority discrete I/O modules 14 each include software control for placing a change-of-state signal on the bus 16 to be communicated to the bus master 12 in response to a state change of the respective high priority discrete I/O module. Thus, only the high priority change-of state signals will be placed on the bus 16 to minimize bus traffic.

Each of the I/O modules 14 (analog or discrete) on the bus 16 will also place their respective data on the bus in response to a respective, unique trigger signal. The bus master 12 includes trigger software control for selectively sending a selected trigger signal from the bus master 12 on to the bus 16. The trigger signal is received by a selected one of the I/O modules 14 (analog or discrete), to poll the selected I/O module for its data. Thus the bus master 12 is able to selectively poll the I/O modules 14, depending upon the relative priority of their data, again minimizing bus traffic.

The bus master 12 issues a trigger signal once it has sufficiently processed incoming messages, so that it is able to receive and process additional messages. This prevents bus overload and insures that all incoming messages—particularly incoming change-of-state messages from the high priority discrete I/O modules 14—are received and processed.

CAN utilizes a standard error detection mechanism to shut down network nodes 14 if excessive errors are encountered. An error counter is increased by a predetermined amount, e.g., 8, for each detected error and decreased by another value, e.g., 1, for each good message received. For such an error detection mechanism, an error rate of 0.1 will never reach the point of requiring node shutdown. However, a rate of 0.125 or higher will eventually require the node 14 to be shut down, though it may take a period of time. Instead of shutting the node 14 down, the bus 16 should be shut down if the expected interval between residual error is significantly less than the mean time between failures (MTBF).

Referring to FIG. 2, a flowchart depicts one embodiment of a process for improving communication throughout a CAN network. Network communication is monitored for bit errors 202. Detected bit errors are compiled 204. A raw bit error rate is calculated 206. The calculated bit error rate is correlated to an undetected, residual, error probability 208. The determination of the residual error probability can be acquired through any means known to one of ordinary skill in the art.

A user defined threshold level of residual bit errors is compared against the residual error probability extrapolated from the detected bit errors 210. If the threshold level is exceeded, corrective actions will be initiated to reduce the effects of the elevated error rate 212. Preferably, transmitted network message, e.g., change-of-state (COS) messages, will be sent at least twice. Although amount of repetitive transmission implemented is changeable and can be set to a desirable value, the transmission rate should be sufficient to bound the residual errors to a predetermined threshold. The redundant transmissions are applicable for reflex (pure COS) outputs from the bus coupler and to remote, triggered inputs. For the triggered inputs, the redundant transmissions will occur upon receipt of later trigger signals. By repetitively transmitting network messages only during prescribed situations, network bandwidth is more efficiently utilized.

Other corrective actions include shortening the length of the messages transmitted, and if needed, shutting down the communication bus.

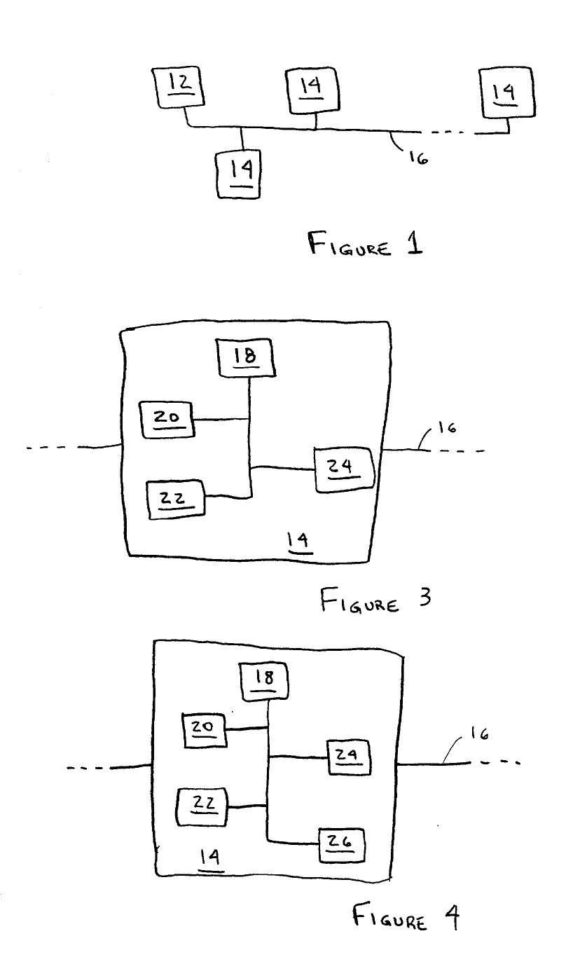

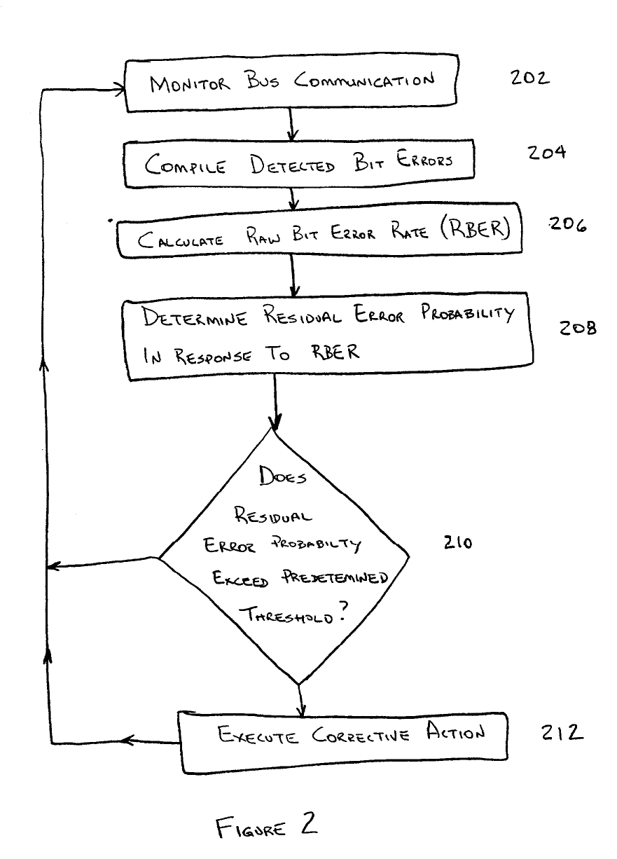

Referring to FIG. 3, another embodiment of the present invention depicts a bit error detector 18 is operably connected to the network 10 and a calculator 20. The calculator 20 is capable of determining the detected bit error rate. An extrapolator 22 correlates the detected bit error rate into an undetected bit error probability. Means for improving accurate transmission 24, e.g., retransmitter, is responsive to the undetected bit rate probability such that if the undetected bit error rate probability exceeds a user defined threshold, corrective action will be executed to improve the accuracy of the network's communication wherein undetected errors transmitted throughout the network 10 are bound to a predetermined threshold.

Another embodiment of correlating a residual error probability from a calculated detected bit error rate includes an 8 bit counter for monitoring of the bit error detection. Each time a bit error is detected, the counter is incremented, preferably by 255. If a message is received without an error, the counter is decreased, e.g., by1. Whenever the counter is non-zero, all COS messages will be transmitted more than once. Additionally, a flag bit can be set and read by a network device. Also, whenever the network 10 is operating in the redundant transmission mode, an LED can be illuminated to alert operating personnel.

Referring to FIG. 4, another embodiment of the present invention is shown wherein the communication bus 14 is monitored for detected errors. A counter 24 for counting detected bit errors is operably connected to a detector 18. A calculator 20 determines the detected bit error rate. An extrapolator 22 correlates the detected bit error rate into an undetected bit error probability. A comparator 26 compares the undetected bit error probability with a predetermined threshold and a corrective action signal is generated in response to the comparison. Exceeding the threshold sets a flag. In response to the flag, a means for improving accurate message transmission is initiated wherein undetected bit errors transmitted throughout the network are bound to a predetermined threshold.

Is further contemplated by the present invention to utilize Packet Identifiers (PID) during monitoring and detection of bit errors. A PID is a code often incorporated within satellite communication systems for the identification of components that form a particular service in a transmitted datastream. Although presently not incorporated in the CAN protocol, this identification technique can be readily adapted for use in CAN.

While the specific embodiments have been illustrated and described, numerous modifications come to mind without significantly departing from the spirit of the invention and the scope of protection is only limited by the scope of the accompanying claims.

We claim:

1. A method for improving communication throughout a network, the network including a module capable of transmitting messages in response to a change of state, the method comprising:
detecting an error;
calculating a raw bit error rate;
correlating a residual error probability in response to the detected error rate; and,
executing a corrective action related to transmitting messages, the execution being activated in response to the residual error probability.

2. The method of claim 1 wherein executing a corrective action comprises retransmitting a message wherein redundant transmissions occur at a rate sufficient to bound the residual errors to a predetermined threshold.

3. The method of claim 1 wherein executing a corrective action comprises shortening the length of the message.

4. The method of claim 1 wherein executing a corrective action comprises ceasing transmission of the message.

5. The method of claim 1 wherein correlating a residual error probability utilizes maximum-likelihood filtering.

6. The method of claim 5 wherein the maximum-likelihood filtering utilizes Kalman filtering.

7. The method of claim 1 wherein correlating a residual error probability utilizes rate of deterioration (first time derivative of measured error rate).

8. The method of claim 1 wherein detecting the error utilizes a packet identifier, PID; PID is a code used for identifying of the components that forms a particular service in the transmitted datastream.

9. A method for reducing the effects of residual errors in a CAN network, the network including a module capable of transmitting messages in response to a change of state, the method comprising:
monitoring a detected error rate;
extrapolating an undetected error rate probability in response to the detected error rate;
executing a corrective action related to transmitting messages in response to the undetected error probability.

10. The method of claim 9 wherein executing a corrective action comprises repetitively transmitting a network message in response to a change of state wherein the repetitive transmissions occur at a rate sufficient to bound the undetected errors to a predetermined threshold.

11. The method of claim 9 wherein executing a corrective action comprises shortening the length of the message.

12. The method of claim 9 wherein executing a corrective action comprises ceasing transmission of the message.

13. The method of claim 9 wherein correlating an undetected error probability utilizes maximum-likelihood filtering.

14. The method of claim 13 wherein the maximum-likelihood filtering utilizes Kalman filtering.

15. The method of claim 9 wherein correlating an undetected error probability utilizes rate of deterioration (first time derivative of measured error rate).

16. The method of claim 9 wherein detecting the error utilizes a packet identifier.

17. An apparatus for reducing the effect of undetected communication errors transmitted throughout a network, the network having a module and being configured such that messages are transmitted from the module in response to a change of state of the module, the apparatus comprising:
means for determining an undetected bit error probability; and,
means for improving accurate message transmission being responsive to the means for determining an undetected bit error probability wherein undetected bit errors transmitted throughout the network are bound to a predetermined threshold.

18. The apparatus of claim 17 further comprising means for determining a detected bit error rate.

19. The apparatus of claim 18 wherein the means for determining a detected bit error rate comprises:
a bit error monitor for detecting bit errors;
a counter being operably responsive to the monitor, the counter being capable of tallying an amount of detected bit errors; and,
a calculator being operably connected to the counter, the calculator being capable of determining a detected bit error rate in response to the amount of detected bit errors.

20. The apparatus of claim 19 wherein the means for determining an undetected bit error probability comprises:
an extrapolator for correlating an undetected bit error probability in response to the determined detected bit error rate.

21. The apparatus of claim 17 further comprising:
a corrective action flag, the corrective action flag being set in response to the undetected bit error probability exceeding a predetermined threshold.

22. The apparatus of claim 17 wherein the means for improving accurate message transmission comprises:
a message repeater for repetitively transmitting messages throughout the network in response to a change of state and at a rate sufficient to bound the undetected errors to a predetermined threshold.

23. The apparatus of claim 17 wherein the means for improving accurate message transmission comprises:
a shortened message length.

24. The apparatus of claim 17 wherein the means for improving accurate message transmission comprises:
a message transmission terminator for ceasing transmission of network messages.

25. The apparatus of claim 17 further comprising:
a maximum-likelihood filter being operably connected to the extrapolator.

26. The apparatus of claim 25 wherein the maximum-likelihood filter is a Kalman filter.

27. The apparatus of claim 17 further comprising:
a differentiator being operably connected to the extrapolator for determining the first derivative of the calculated detected bit error rate.

28. The apparatus of claim 17 further comprising:
a packet identifier, the packet identifier being a portion of the message and being utilized by the bit error detector for detecting a message having an error.

30. An apparatus for reducing the effect of undetected communication errors transmitted throughout a network, the network having a module and being configured such that messages are transmitted from the module in response to a change of state of the module, the apparatus comprising:
a detector for detecting bit errors;
a counter for counting detected bit errors, the counter being operably connected to the detector;
a calculator for determining a detected bit error rate, the calculator being operably connected to the counter;
an extrapolator for correlating an undetected bit error probability, the extrapolator being operably connected to the calculator;
a predetermined undetected bit error probability threshold;
a comparator providing a corrective action signal, the corrective action signal being generated in response to a comparison of the undetected bit error probability and the predetermined threshold wherein the undetected bit error probability exceeds the predetermined threshold; and means for improving accurate message transmission being responsive to the corrective action signal wherein undetected bit errors transmitted throughout the network are bound to a predetermined threshold.

31. The apparatus of claim 30 wherein the means for improving accurate message transmission comprises:
a message repeater for repetitively transmitting messages throughout the network in response to a change of state and at a rate sufficient to bound the undetected errors to a predetermined threshold.

32. The apparatus of claim 30 wherein the means for improving accurate message transmission comprises:
a shortened message length.

33. The apparatus of claim 30 wherein the means for improving accurate message transmission comprises:
a message transmission terminator for ceasing transmission of network messages.

34. The apparatus of claim 30 further comprising:
a maximum-likelihood filter being operably connected to the extrapolator.

35. The apparatus of claim 34 wherein the maximum-likelihood filter is a Kalman filter.

36. The apparatus of claim 30 further comprising:
a differentiator being operably connected to the extrapolator for determining the first derivative of the calculated detected bit error rate.

37. The apparatus of claim 30 further comprising:
a packet identifier, the packet identifier being a portion of the message and being utilized by the bit error detector for detecting a message having an error.

38. A medium readable by a device being operably connected within a CAN network having a bus master and an I/O module operably coupled to a communication bus wherein the I/O module is subject to a state change, the medium containing instructions for improving network communication by reducing the effect of undetected errors, the medium comprising:
a first segment for detecting an error;
a second segment for calculating a bit error rate;
a third segment for correlating an undetected error probability in response to the detected error rate; and a fourth segment for executing a corrective action to improve message transmission throughout the network, the execution being activated in response to the undetected error probability and the change of state of the I/O module.

39. The medium of claim 38 wherein the fourth segment retransmits a message wherein redundant transmissions occur at a rate sufficient to bound the residual errors to a predetermined threshold.

40. The medium of claim 38 wherein the fourth segment shortens the length of the transmitted message.

41. The medium of claim 38 wherein the fourth segment ceases module messages transmissions.

42. The medium of claim 38 wherein the third segment utilizes maximum-likelihood filtering.

43. The medium of claim 42 wherein the maximum-likelihood filtering utilizes Kalman filtering.

44. The medium of claim 38 wherein the third segment utilizes rate of deterioration of the calculated bit error rate.

45. The medium of claim 38 wherein the first segment utilizes a packet identifier.
